(19) United States
(12) Patent Application Publication
(10) Pub. No.: US 2026/0305532 A1
(43) Pub. Date: Oct. 8, 2026

(54) PICK-UP ATTACHMENT FOR A HARVESTING MACHINE

(71) Applicant: Carl Geringhoff GmbH & Co. Kommanditgesellschaft, Ahlen (DE)

(72) Inventors: André HEMMESMANN, Sassenberg (DE); Holger STRUNK, Wadersloh (DE); Cristiano SCHWARTZ, Ahlen (DE); Jonas SCHOLZ, Sendenhorst (DE)

(73) Assignee: Carl Geringhoff GmbH & Co. Kommanditgesellschaft, Ahlen (DE)

(21) Appl. No.: 19/482,879

(22) PCT Filed: May 2, 2024
(86) PCT No.: PCT/DE2024/100400

§ 371 Date: Nov. 10, 2025

(30) Foreign Application Priority Data
May 12, 2023 (DE) 10 2023 112 629.6

(51) Int. Cl. A01D 89/00; A01D 43/00; A01D 43/08

(52) U.S. Cl. CPC A01D 89/008; A01D 43/006; A01D 43/085; A01D 89/002

(57) ABSTRACT

A pick-up attachment for a harvesting machine, preferably for a forage harvester, particularly preferably for a self-propelled forage harvester, has a machine frame and an adapter frame, to the forward-facing side of which, as seen in the direction of travel, the machine frame is hingedly attached and to the rearward-facing side of which the pre-compression housing of the harvesting machine, or the harvesting machine, is coupleable so as to be fixed in place. The machine frame is swingable or tiltable downwards and upwards relative to the adapter frame about a rotation axis transverse to the travel direction, arranged in the lower region of the machine frame and of the adapter frame, or about at least one correspondingly arranged pivot point. At least one rocker mechanism, including a rotatably mounted rocker, is arranged on the adapter frame in the upper region of the adapter frame and has two rocker arms.

The invention relates to a pick-up attachment for a harvesting machine having, in particular, a pre-compression housing, preferably for a forage harvester having, in particular, a pre-compression housing, particularly preferably for a self-propelled forage harvester having, in particular, a pre-compression housing, wherein the pick-up attachment has a machine frame.

Forage harvesters are harvesting machines that are used to harvest and collect crop, cut harvested crop to short parallel lengths, and convey the chopped material into containers or separate vehicles. Typical harvested crops are grasses, stalk-like crops, such as alfalfa or field grass, legumes, mixtures and/or row crops, such as corn or millet. The chopped material can either be fed directly to the livestock as feed or stored by silage or drying in order to feed this to the livestock later as feed. The forage harvester can harvest the crop directly by cutting in full width, or from individual rows or multiple rows, or by picking up from the swath. Forage harvesters can be mounted on the tractor, drawn by a tractor, or self-propelled.

A front harvesting attachment is a typically removable device for feeding the harvested crop into the harvesting machine, in particular into the forage harvester. A front harvesting attachment in the form of a pick-up attachment is specifically a device for picking up previously cut crop. The crop can be set down in rows or swaths.

Self-propelled forage harvesters have now reached an engine power of over 1000 HP. In parallel with the engine power, the throughput capacity of forage harvesters has also increased. In addition to the high engine power and throughput capacity necessary for corn silage, the harvesting capacity is also an important factor for high feed quality in grass silage. After mowing, the meadows and fields must be cleared within a short time window in order to thereby be able to silage, for example, the green crop with an optimal content of dry substance.

In order to be able to take full advantage of the high throughput capacity of a harvesting machine, in particular of a forage harvester, it is inter alia necessary to considerably increase the ground speed of the harvesting machine.

The increase in the working speed, or the ground speed, of the harvesting machine, in particular of the forage harvester, as an increase in harvesting capacity that is quasi neutral with regard to investment, is associated with negative side effects, which are described in greater detail in the following.

The drivers of forage harvesters and transfer vehicles require a considerably higher degree of concentration at higher ground speeds, and therefore exhaustion is reached much sooner. As a result, changes in the contour of the ground caused, for example, by ditches, i.e., by narrow trenches between individual fields used for water drainage, by wet areas, or by other obstacles, are detected late, as a result of which it becomes difficult to manually adapt the ground speed and the height of the pick-up attachment in a timely manner.

Known pick-up attachments comprise an, in particular, rigid, roller-like pick-up rotor with pick-up tools, for example, an, in particular, rigid tine drum, for picking up harvested crop from the ground. The, in particular, rigid pick-up rotor is fixedly, i.e., quasi rigidly, connected to the machine frame of the pick-up attachment, or is linked thereto. The machine frame in turn can be rigidly connected to the pre-compression housing of the harvesting machine, in particular of the forage harvester. Such pick-up rotors cannot adapt to the contour of the ground separately, i.e., separated from the machine frame of the pick-up attachment. Pick-up attachments are also known, which are rigidly connected as such to the machine frame of the harvesting machine, in particular of the forage harvester, or are linked thereto. Pick-up attachments that are rigidly attached to the harvesting machine or pick-up attachments with rigidly attached pick-up rotors usually have poor ground guidance in undulating regions. Ground pressure controllers for height guidance known from the prior art respond too sluggishly at high ground speeds. The consequences of the poor ability of the pick-up attachment to follow ground contours are crop losses, excessive contamination of feed, and increased machine wear.

Pick-up attachments or, in particular, rigid pick-up rotors, are also known, which are suspended together with the intake auger base, which can also be referred to as an auger base, as a unit in each case on the machine frame of the pick-up attachment in a swinging manner or as a unit in each case swinging with respect to the intake auger, wherein these ensure a considerably better adaptation to the ground contour and, thus, an approximately exact adherence to the rake height at high ground speeds of the pick-up attachment. A pick-up attachment in which the pick-up rotor is attached to the auger base as a unit via two arms, via a left arm and a right arm as seen in the direction of travel, swinging up and down relative to the machine frame of the pick-up attachment, is known from the company CLAAS KGaA mbH. The pick-up rotor, or the unit consisting of the pick-up rotor and the auger base, can adapt to quickly changing ground contours. This type of attachment has an axis of rotation, or a pivot point, which is arranged relatively low to the ground, which can be soil, in order to thereby generate a thrust vector that is as flat as possible.

The invention is based on the finding that the main disadvantage of this suspension is the resultant relative movement between the pick-up rotor and the intake auger, which disturbs the flow of harvested crop and can even cause damage to the machine. This is due to the fact that the auger flights of the intake auger must have an approximately constant distance from the auger base and that the pivot point of the intake auger must be arranged farther upward, i.e., spaced from the pivot point of the unit consisting of the pick-up rotor and the auger base. If the unit, or the system, swings, or moves, upwards, the intake auger approaches the pick-up rotor, predominantly horizontally. As a result, the distance between pick-up tools, in particular the pick-up tines, and auger flight becomes very small, such that the transverse conveyance of the flow of harvested crop is impeded by the pick-up tools, in particular by the pick-up tines. This can even give rise to an increased breakage of tines. If the unit swings, or moves, downwards, the intake auger moves away from the pick-up rotor, predominantly horizontally. As a result, the distance between pick-up tools, in particular pick-up tines, and auger flight becomes very large, such that the transfer of the harvested crop from the pick-up rotor to the intake auger is impeded. As a result, the flow of harvested crop can stop, which in turn results in an uneven loading of the harvesting machine, in particular of the forage harvester, as a result of which the chopping performance and chopping quality are reduced.

It is known that harvesting machines, for example, forage harvesters, usually have a ground pressure controller and a lateral tilt frame for the height guidance or adaptation to ground contours by the pick-up attachment. The lateral tilt frame is usually a frame-shaped element which is articulated, with one side, on the harvesting machine, for example, on the front end of the forage harvester as seen in the direction of travel, so as to be swivelable about a pivot axis and, with the other side, is fastened to the pick-up attachment or is supported against the machine frame of the pick-up attachment. The lateral tilt frame therefore enables a swivel motion of the pick-up attachment with respect to the harvesting machine, in particular to the forage harvester, about a horizontal pivot axis, which extends in the direction of travel. The movement direction of the lateral tilt of the pick-up attachment relative to the harvesting machine, in particular to the forage harvester, is therefore transverse to the direction of travel. The swiveling of the pick-up attachment and of the lateral tilt frame about the pivot axis can take place by gravity, or external-force-actuated actuators are provided, which automatically vary or control the swivel angle about the pivot axis on the basis of signals from sensors, which are distributed over the width of the pick-up attachment, for detecting the height above the ground and/or the ground pressure. The disadvantage of a ground pressure controller, however, is that this responds sluggishly, such that this can no longer operate effectively and responsively at higher ground speeds. As a consequence thereof, the pick-up attachment poorly adapts to ground contours, which in turn results in crop losses, excessive contamination of feed, and increased machine wear, as explained in greater detail in the following.

If the harvesting machine, in particular the forage harvester, travels at an increased ground speed through a depression, the ground pressure controller cannot lower the pick-up attachment in a timely manner, such that this is guided too high for a certain time and distance, wherein the pick-up tools, in particular rake tines, of pick-up rotor no longer extend to the topsoil, which results in crop losses, since crop material is not collected. The result, therefore, is crop losses that remain on the field, since the optimal rake height could not be maintained. Traversing a depression refers in this case to traveling into the depression. Conversely, it could also be stated that, when the harvesting machine, in particular the forage harvester, traverses a depression at an increased ground speed, the ground pressure controller cannot raise the pick-up attachment and, thus, the pick-up rotor, in a timely manner, such that this is guided too low for a certain time and distance. Traversing a depression refers in this case to traveling out of the depression back into the plane. As a result, the pick-up tools, in particular rake tines, of the pick-up rotor aggressively comb through the ground, or through the topsoil, which results in excessive contamination of the harvested crop and, thus, contamination of the feed and, therefore, a reduction in feed quality, damage to the topsoil, and increased wear both on the pick-up attachment and on the harvesting machine, for example, on the forage harvester, since a large amount of filth, in particular sand and ground, is also picked up. Breakage of the pick-up tools, in particular of the rake tines, as well as other damage is also possible.

If the harvesting machine, in particular the forage harvester, travels at an increased ground speed over a summit, the ground pressure controller cannot raise the pick-up attachment in a timely manner, such that this is guided too low for a certain time and distance. As a result, the pick-up tools, in particular rake tines, of the pick-up rotor aggressively comb through the ground, or through the topsoil, which results in excessive contamination of the harvested crop and, thus, contamination of the feed and, therefore, a reduction in feed quality, damage to the topsoil, and increased wear both on the pick-up attachment and on the harvesting machine, for example, on the forage harvester, since a large amount of filth, in particular sand and ground, is also picked up. Breakage of the pick-up tools, in particular of the rake tines, is also possible. Traveling over a summit relates in this case to traveling onto the summit. Conversely, it could also be stated that, when the harvesting machine, in particular the forage harvester, travels over a summit at an increased ground speed, the ground pressure controller cannot lower the pick-up attachment in a timely manner, such that this is guided too high for a certain time and distance, wherein the pick-up tools, in particular rake tines, of the pick-up rotor no longer extend to the topsoil, which results in crop losses, since crop material is not collected. The result, therefore, is crop losses that remain on the field, since the optimal rake height could not be maintained. Traveling over a summit refers in this case to traveling from the summit back into the plane.

The rake height refers to the distance between rake point and ground, or topsoil, wherein the rake point lies at the point where the envelope curve of the pick-up tools, in particular of the pick-up tines, or rake tines, of the pick-up rotor has the smallest distance to the ground, or to the topsoil. The rake height, or the distance of the pick-up tools to the ground, should always be such that the crop can be picked up from the ground completely, i.e., without losses, and fed to the harvesting machine, in particular to the forage harvester.

The problem addressed by the invention is that of improving a pick-up attachment for a harvesting machine having, in particular, a pre-compression housing, preferably for a forage harvester having, in particular, a pre-compression housing.

This problem is solved by a pick-up attachment having the features of Claim 1. Developments and advantageous embodiments of the invention can be gathered from the dependent claims.

The pick-up attachment according to the invention for a harvesting machine having a pre-compression housing, preferably for a forage harvester having a pre-compression housing, particularly preferably for a self-propelled forage harvester having a pre-compression housing, wherein the pick-up attachment has a machine frame, is characterized in that the pick-up attachment has an adapter frame, to the forward-facing side of which, as seen in the direction of travel, the machine frame is hingedly attached and to the rearward-facing side of which the pre-compression housing of the harvesting machine, or the harvesting machine, is coupleable so as to be fixed in place, wherein the machine frame is swingable or tiltable upwards and downwards relative to the adapter frame about an axis of rotation arranged transversely to the direction of travel, arranged in the lower region of the machine frame and of the adapter frame, or about at least one correspondingly arranged pivot point, wherein at least one rocker mechanism is provided, comprising a rotatably mounted rocker, which is arranged on the adapter frame in the upper region of the adapter frame and has two rocker arms, wherein the one rocker arm is attached to the machine frame in the upper region of the machine frame directly or indirectly, preferably via a draw bar, wherein the other rocker arm is attached to the machine frame in the lower region of the machine frame or to the adapter frame in the lower region of the adapter frame via a tension spring and/or the like.

Instead of the tension spring or in addition to the tension spring, other correspondingly acting energy stores, for example, hydraulic cylinders, are also usable according to the invention. This explains the term “the like.”

The invention is based on the concept that, for an optimal adherence or adaptation by the rake elements, in particular by the pick-up tools, to the ground contour, above all at higher ground speeds, the pick-up attachment, at least, however, the pick-up rotor, must be attached swinging up and down relative to the pre-compression housing of the forage harvester. Thus, the pick-up rotor can adapt highly directly and responsively to the ground contours independently of the chopper-side ground pressure controller.

A considerable portion of the weight of the pick-up attachment is transferred from guide elements, in particular roller feelers or sensing skids, onto the ground, which can be soil.

The invention is based on the concept of adjusting the pressure on the ground to be as low as possible and as high as necessary.

If the ground pressure is too high, the topsoil can become damaged above all on wet and/or mucky surfaces. The guide elements can sink in, such that the rake height is no longer be reliably maintained. As a result, an increased contamination of feed, damage to the topsoil, and increased wear in the pick-up attachment and in the harvesting machine, in particular in the forage harvester, up to breakage of pick-up tools or tines, or further machine damage can result. In addition, the deflection force, which, due to changes in the contour of the ground, raises the pick-up attachment over its roller feelers, increases. This impairs the responsiveness of the system.

If the ground pressure is too low, the pick-up attachment can wind up in a type of “limbo.” This also diminishes the responsiveness of the system, such that the pick-up attachment cannot or can only very slowly follow the contour changes, in particular the dropping. As a result, crop losses can arise, above all at high ground speeds.

The invention is also based on the concept that, as a result of an optimal adjustment of the ground pressure, the smooth running, the adaptation to ground contours, and the responsiveness of the pick-up attachment are improved, which positively affects the soil conservation, the crop losses, the chopping performance and chopping quality, and, ultimately, the feed quality.

In order to be able to adjust the optimal ground pressure for the particular harvesting conditions, the machine frame is relieved from load according to the invention using at least one tension spring, such that a defined ground pressure is adjustable. The tension spring is arranged between adapter frame and machine frame via a rocker mechanism.

Using the provided rocker mechanism according to the invention, or the rocker provided according to the invention, which is operatively connected to the tension spring, the machine frame is relieved from load in a defined manner. As a result, the pressure that the guide elements of the pick-up attachment exert on the ground is reduced.

Due to the arrangement, according to the invention, of the rocker mechanism, or the rocker, the pivot spacing between tension vector of the tension spring and the pivot point between machine frame and adapter frame and/or the tension vector angle of the tension spring with respect to the pivot spacing is changed such that, depending on the position or location of the machine frame relative to the adapter frame, the pivot spacing and/or tension vector angle increases or decreases such that, despite the spring force changing the position, the product of spring force, tension vector angle, and/or and pivot spacing is approximately constant. As a result, the ground pressure, or the supporting force of the guide elements, is always approximately constant relative to the adapter frame regardless of the position of the machine frame.

A pick-up attachment according to the invention is characterized in that it responsively adapts to the ground contours also at high ground speeds and, at the same time, holds the transfer geometries between the different process-related modules of the pick-up attachment, such as pick-up rotor, hold-down device, intake auger, and intake auger base, constantly optimal with respect to one another, i.e., approximately fixed in place and in an optimal position with respect to one another. According to the invention, at the same time, an optimal and safe ground guidance of the pick-up rotor and, thus, a high raking accuracy are also achieved at high ground speeds of the harvesting machine, in particular of the forage harvester. In addition, an optimal flow of harvested crop and a uniform compression of the crop mat and, thus, high chopping performance and chopping quality are ensured.

The rocker mechanism substantially consists, as claimed, of a draw bar, the rocker, and of at least one tension spring. The tension spring is preferably hingedly connected via its lower end to the machine frame. Its upper end is preferably hingedly connected to the rocker, or to the rocker arm, preferably via an adjusting screw with which a preload of the tension spring is adjustable according to a development of the invention. The rocker is rotatably attached to the adapter frame on an axis which is oriented transversely to the direction of travel and arranged at a distance above the pivot point between machine frame and adapter frame. The tension spring engages at the rear rocker arm, or the rear end of the rocker, i.e., the end pointing counter to the direction of travel. The draw bar, which can also be referred to as pull-push rod, hingedly engages via its rear end at the front rocker arm, or the front end of the rocker, i.e., the end pointing in the direction of travel. The front end of the pull-push rod is hingedly connected to the machine frame.

The rocker mechanism can be advantageously designed such that the product of spring force and pivot spacing describes a progressive, degressive, or linear course.

When the machine frame is in the lower end position relative to the adapter frame, i.e., when the machine frame is tilted all the way down about the axis of rotation, the resultant ground pressure, or the supporting force of the guide elements, becomes low and, when there is a relevant change in the ground contour, the machine frame can be relatively easily pressed upwards.

When the machine frame is in the upper end position relative to the adapter frame, i.e., when the machine frame is pressed all the way up about the axis of rotation, the resultant ground pressure, or the supporting force of the guide elements, becomes high. As a result, when there is a relevant change in the ground contour, the machine frame can relatively easily drop downwards.

The change in the ground pressure between the lower and the upper end positions can describe a progressive, a degressive, or a linear course. A linear course is preferred.

It can be advantageous when the rocker is tiltable about an axis of rotation arranged transversely to the direction of travel, or about at least one correspondingly arranged pivot point, wherein the axis of rotation of the rocker, or at least the correspondingly arranged pivot point, is arranged at a predefined distance above the axis of rotation formed between the adapter frame and machine frame.

It can be advantageous when the pick-up attachment has two rocker mechanisms, wherein the one rocker is arranged on the left outer side of the adapter frame as seen in the direction of travel and the other rocker is arranged on the right outer side of the adapter frame as seen in the direction of travel.

It can be advantageous when the pick-up attachment comprises a pick-up rotor with pick-up tools for picking up crop from the ground, at least one guide element lying on the ground, which takes on the guidance of the pick-up rotor and guides this towards the ground, a hold-down device, an intake auger base, and an intake auger for uniformly handing off the picked-up crop to the harvesting machine.

It can be advantageous when the machine frame and the adapter frame are coupled via their axis of rotation and the at least one rocker mechanism, which has a rocker, a tension spring, and, optionally, a draw bar, such that, when the machine frame swings downwards about the axis of rotation, in particular when the pick-up attachment travels into a depression, the tension spring extends and its spring force is correspondingly increased, and vice versa, such that, when the machine frame swings upwards about the axis of rotation, in particular when the pick-up attachment travels onto a summit, the tension spring contracts and its spring force is correspondingly decreased.

It can be advantageous when a defined distance or leverage is formed between the effective direction of the tension spring and the axis of rotation, or the pivot point, which, in an operative connection with the spring force of the tension spring, partially guides the weight of the machine frame into the adapter frame such that the ground pressure, or the supporting force of the guide elements on the ground, changes, in particular decreases.

As described above, the tension spring extends in response to the relative motion between machine frame and adapter frame when the machine frame tilts downwards about the axis of rotation, wherein the spring force increases, or the tension spring contracts in response to the relative motion between machine frame and adapter frame when the machine frame is pressed upwards about the axis of rotation, wherein the spring force decreases. Due to the rocker mechanism, the distance between the effective direction of the tension spring and the pivot point, in any position of the machine frame relative to the adapter frame, can be kept variable in a defined manner, such that the product of spring force, tension vector angle, and/or pivot spacing is constant. This yields an approximately constant ground pressure which is exerted by the guide elements on the soil regardless of the position of the machine frame relative to the adapter frame. The value of the ground pressure can be adjusted, or changed, by correspondingly changing the preload of the tension spring.

It can be advantageous when the tension spring is preloaded or preferably has a predefined or predefinable preload. As a result, the desired value of the pressure exerted by the guide elements on the ground can be predefined.

It can be advantageous when the preload of the tension spring is adjustable or changeable, preferably by means of an adjusting element, in particular an adjusting screw, on the tension spring. As a result, the ground pressure of the guide elements can be adapted to different ground conditions.

It can be advantageous when the axis of rotation or the pivot point is arranged at the level of the intake auger base.

It can be advantageous when the pick-up rotor, the hold-down device, the intake auger base, and the intake auger are attached to the machine frame and these, together with the machine frame, form a machine frame unit, wherein this machine frame unit is suspended swinging up and down relative to the pre-compression housing of the harvesting machine, in particular of the forage harvester. Since the machine frame is, according to the invention, hingedly attached to the adapter frame, all aforementioned process-related components of the pick-up attachment therefore swing along, i.e., up and down, or upwards and downwards.

In other words: The pick-up attachment according to the invention, or its pick-up rotor, advantageously responsively adapts to the ground contour, in that this, together with all important process-related components, is attached to a common machine frame, wherein the machine frame is hingedly coupled to the adapter frame. The rocker system according to the invention makes it possible to hold the supporting force of the guide elements, or the ground pressure exerted by the guide elements on the ground, for example, the soil, constant regardless of the position of the machine frame relative to the adapter frame.

The rocker mechanism according to the invention, or the rocker system according to the invention, can also be designed such that the ground pressure increases from the lower end position of the machine frame relative to the adapter frame up to the upper end position of the machine frame relative to the adapter frame. In the lower end position, the ground pressure is relatively low, while the ground pressure in the upper end position is relatively high, i.e., higher than in the lower end position. The function of the change in ground pressure from the lower end position to the upper end position of the machine frame can be progressive, degressive, and/or linear. Advantageously, the function, or the change in ground pressure, is approximately linear.

The pick-up attachment, or the pick-up rotor, responsively swings downwards during a traverse of a depression relative to the pre-compression housing of the harvesting machine also at high ground speeds and, thus, holds the adjusted rake height constant, such that no crop remains on the ground and no feed losses arise.

The pick-up attachment, or the machine frame, responsively swings upwards relative to the adapter frame or to the pre-compression housing of the harvesting machine when traveling over a summit also at high ground speeds and, thus, holds the adjusted rake height constant, such that no contaminants enter the feed and the topsoil is conserved.

Thus, a very good ground guidance and, as a result, a low-loss and low-contaminant pick-up of the harvested crop, or feed, is ensured under all conditions. At the same time, the feed quality, the chopping quality, and the harvesting capacity are thus increased in the constantly homogeneous flow of harvested crop. Moreover, the ground pressure can be held constant in all positions by means of the rocker mechanism.

It can be advantageous when the machine frame, which is hingedly attached to the adapter frame, swings about the axis of rotation or the pivot point such that no or only slight changes in the transfer geometry between pick-up attachment and pre-compression housing of the harvesting machine, or of the harvesting machine, arise during the up-and-down-swinging motion. To this end, as described above, the pivot point or the axis of rotation is arranged between machine frame and adapter frame at the level, in particular in the region of the highest transfer point, of the transfer base, or intake auger base, or auger base.

As a result, an optimal and safe ground guidance of the pick-up rotor and, thus, a high raking accuracy are also achieved at high ground speeds of the harvesting machine, in particular of the forage harvester. In addition, an optimal flow of harvested crop and a uniform compression of the crop mat and, thus, high chopping performance and chopping quality are ensured.

It can be advantageous when two guide elements, which are preferably designed as roller feelers, are arranged on the left and the right as seen in the direction of travel, laterally next to the pick-up rotor, preferably approximately at the level of the pick-up rotor as seen in the direction of travel. With the guide elements, the pick-up rotor and, thus, the machine frame of the pick-up attachment are guided towards the ground.

It can be advantageous when the contact point of the two guide elements, preferably of the roller feelers, with the ground is arranged, as seen in the direction of travel, approximately next to the contact point of the pick-up tools, in particular, pick-up tines, or rake tines, of the pick-up rotor with the ground, the so-called rake point.

As a result, the adjusted rake height of the pick-up rotor, or of the pick-up tools, in particular of the pick-up tines, is always exactly maintained regardless of the position, or the angle, of the pick-up rotor or machine frame relative to the pre-compression housing, or of the soil.

It can be advantageous when the distance of the pick-up tools, in particular of the pick-up tines, or rake times, of the pick-up rotor to the ground, or the rake height, is adjustable using the guide elements, preferably roller feelers, arranged laterally next to the pick-up rotor.

It can be advantageous when the guide elements, preferably roller feelers, are mechanically, hydraulically, and/or electrically movable with respect to their height to adjust the distance of the pick-up tools, in particular the pick-up tines, or rake tines, of the pick-up rotor to the ground.

It can be advantageous when the adjustment of the distance of the pick-up tools, in particular the pick-up tines, or rake tines, of the pick-up rotor to the ground is implementable decentrally at the particular guide element, preferably roller feeler, or centrally from the driver's cab of the harvesting machine and preferably simultaneously for all guide elements.

It can be advantageous when an actuator, preferably a hydraulic actuator, is provided, by means of the actuation of which the swing angle, or the swinging motion, of the rocker is overridable, wherein the machine frame is movable either into an upper end position or into a lower end position, wherein the actuation is preferably implementable from the driver's cab of the harvesting machine.

In this way, for example, for transporting the pick-up attachment on the road, the machine frame can be moved relative to the adapter frame into the upper end position and, thus, greater ground clearance can be generated. In foldable pick-up attachments, the actuator can be used to move the machine frame relative to the adapter frame into its lower end position for the folding operation, in order to thereby create more space for folding, or moving the machine frame between pre-compression housing or cab roof of the harvesting machine, in particular of the forage harvester, and the pick-up attachment.

It can be advantageous when the adapter frame is additionally provided with a lateral tilt frame, which permits the pick-up attachment to swing back and forth transversely to the direction of travel.

As a result, the ground guidance and, thus, the raking quality and feed quality can be considerably improved, above all with forage harvesters with a rigid pre-compression housing, i.e., a pre-compression housing without a separate lateral tilt frame.

It can be advantageous when one or more than one sensor, preferably angle sensor, is provided for electronic height guidance, which detects the relative movement between machine frame of the pick-up attachment and adapter frame of the pick-up attachment due to the swinging suspension, according to the invention, of the machine frame relative to the adapter frame and converts the relative movement into an electrical signal, wherein the signal is then usable to detect the position of the pick-up rotor, or of the machine frame of the pick-up attachment, relative to the adapter frame of the pick-up attachment, or to the pre-compression housing of the harvesting machine, which is usable to control a pre-compression housing arranged on the pick-up attachment, which is tracked such that the swinging machine frame returns to a starting position in which the machine frame is in a central position. The swinging machine frame adapts directly and responsively to the ground contours and, thus, holds the rake height constant also at higher ground speeds.

It can be advantageous when the pick-up attachment connected to the harvesting machine is manually adjustable at the harvesting machine to a constant predefined height above the ground, preferably such that the machine frame is spring-deflected by 50% relative to the adapter frame. As a result, the swinging machine frame can adapt to the ground contours also without a controlled front-attachment height guidance provided on the harvesting machine, or on the forage harvester. This is advantageous, for example, with older models of harvesting machines, or forage harvesters. The machine frame can thus adapt to the ground contours within its swing travel. In the case of more extreme unevenness of the ground, the height of the front attachment must be manually corrected from the driver's cab of the harvesting machine, in particular of the forage harvester. Therefore, this development of the invention is advantageously usable preferably on even terrain.

The invention is implementable with all machines having pick-up attachments.

Given all of the above, the following advantages of a pick-up attachment according to the invention for a harvesting machine, in particular for a forage harvester, in comparison with the prior art are as follows:
better adaptation to ground contours, above all at greater working widths and higher ground speeds
high degree of smooth running of the pick-up rotor, and of the entire pick-up attachment
load peaks are not introduced into the pre-compression housing of the harvesting machine; the pick-up attachment deflects upwards when ground contours change quickly
defined ground pressure on the guide elements
the topsoil is conserved and the rake height is maintained, above all on wet, highly contoured and mucky terrain
higher feed quality; fewer contaminants introduced into the feed
lower wear in the entire pick-up attachment and in the entire harvesting machine
as a result, also a lower risk of tine breakage
lower harvesting losses during pick-up of harvested crop from the ground; raking quality

Further features of the invention can be gathered from the claims, the figures, and the description of the figures. All features and combinations of features mentioned above in the description, as well as the features and combinations of features mentioned in the following in the description of the figures and/or shown individually in the figures, are usable not only in the particular combination indicated, but also in other combinations or alone.

The invention is now explained in greater detail on the basis of preferred exemplary embodiments and with reference to the attached drawings. Wherein:

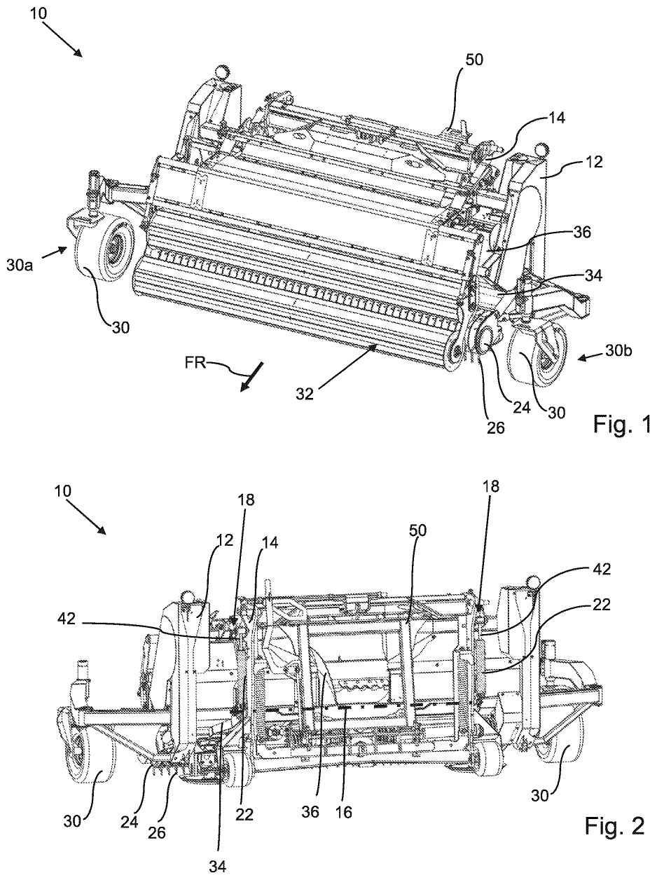

FIG. 1 shows a perspective view of a pick-up attachment according to the invention at an angle from the front,

FIG. 2 shows a perspective view of the pick-up attachment according to the invention shown in FIG. 1 at an angle from the back,

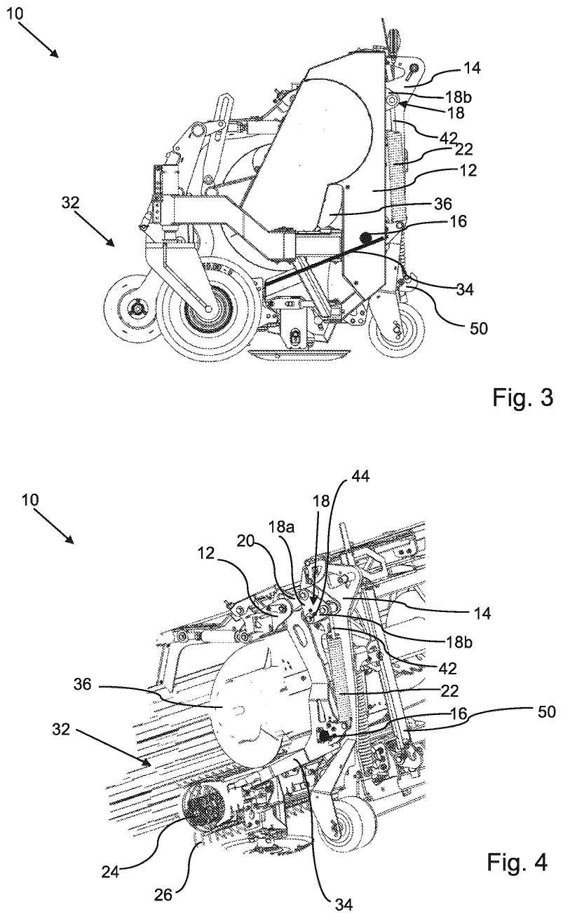

FIG. 3 shows a side view of the pick-up attachment according to the invention shown in FIG. 1,

FIG. 4 shows a perspective detailed view of the pick-up attachment according to the invention shown in FIG. 1 at an angle from the back,

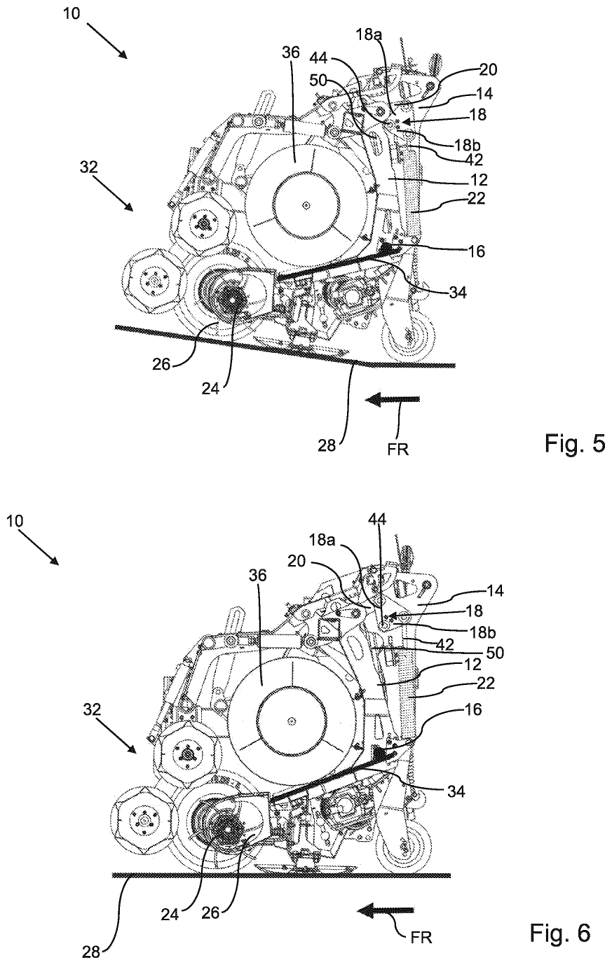

FIG. 5 shows a side view of the pick-up attachment according to the invention shown in FIG. 1 with a machine frame in the upper end position,

FIG. 6 shows a side view of the pick-up attachment according to the invention shown in FIG. 1 with a machine frame in the central position,

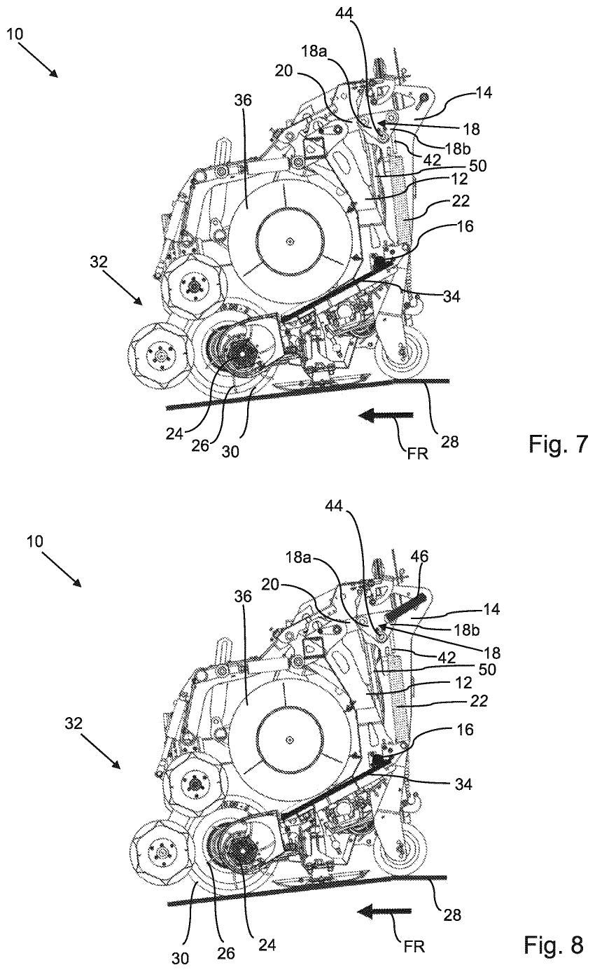

FIG. 7 shows a side view of the pick-up attachment according to the invention shown in FIG. 1 with a machine frame in the lower end position,

FIG. 8 shows a side view of a pick-up attachment according to the invention with an actuator for overriding the swing angle of the rocker, and

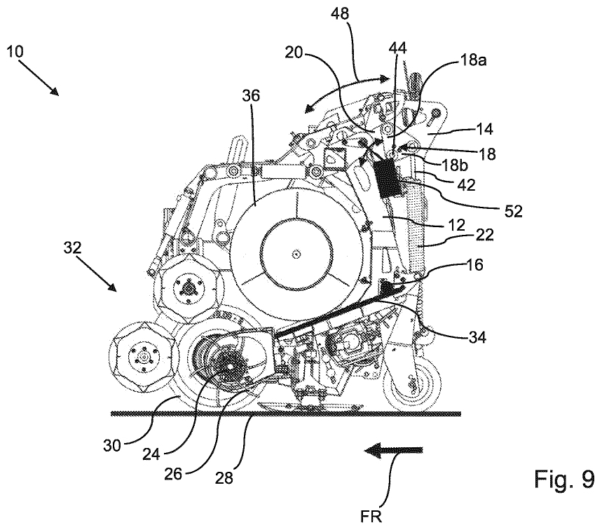

FIG. 9 shows a side view of a pick-up attachment according to the invention with electronic angle/position detection of the machine frame, which is tiltable relative to the adapter frame.

If the same reference numerals are used in FIG. 1 through 9, these also designate the same parts or regions.

The invention relates to a pick-up attachment 10 for a harvesting machine which is not shown here and has, in particular, a pre-compression housing, preferably for a forage harvester which is not shown here and has, in particular, a pre-compression housing, particularly preferably for a self-propelled forage harvester which is not shown here and has, in particular, a pre-compression housing.

The pick-up attachment 10 comprises a pick-up rotor 24 with pick-up tools 26 for picking up crop from the ground 28, two guide elements 30, as roller feelers, lying on the ground 28, which take on the guidance of the pick-up rotor 24 and guide this towards the ground 28, a hold-down device 32, an intake auger base 34, and an intake auger 36 for uniformly handing off the picked-up crop to the harvesting machine.

The pick-up attachment 10 also has a machine frame 12 to which the pick-up rotor 24, the hold-down device 32, the intake auger base 34, and the intake auger 36 are attached, wherein these, together with the machine frame 12, form a machine frame unit, wherein this machine frame unit is suspended swinging up and down relative to the pre-compression housing of the harvesting machine, in particular of the forage harvester.

To this end, the pick-up attachment 10 has an adapter frame 14, to the forward-facing side of which, as seen in the direction of travel FR, the machine frame 12 is hingedly attached and to the rearward-facing side of which the pre-compression housing of the harvesting machine is coupleable so as to be fixed in place, wherein the machine frame is swingable or tiltable upwards and downwards relative to the adapter frame 14 about an axis of rotation 16 arranged transversely to the direction of travel FR, arranged in the lower region of the machine frame 12 and of the adapter frame 14, or about at least one correspondingly arranged pivot point.

According to the invention, the present pick-up attachment has two rocker mechanisms, each of which comprises a rotatably mounted rocker 18, which is arranged on the adapter frame 14 in the upper region of the adapter frame 14 and has two rocker arms 18a, 18b, wherein the one rocker arm 18a is attached to the machine frame 12 in the upper region of the machine frame 12 directly or indirectly, preferably via a draw bar 20, wherein the other rocker arm 18b is attached to the machine frame 12 in the lower region of the machine frame 12 via a tension spring 22.

The rocker 18 is tiltable about an axis of rotation 44 arranged transversely to the direction of travel FR, or about at least one correspondingly arranged pivot point, wherein the axis of rotation 44 of the rocker 18, or at least one correspondingly arranged pivot point, is arranged at a predefined distance above the axis of rotation 16, which is formed between the adapter frame 14 and the machine frame 12.

The one rocker 18 is arranged on the left outer side of the adapter frame 14 as seen in the direction of travel FR and the other rocker 18 is arranged on the right outer side of the adapter frame 14 as seen in the direction of travel FR.

The machine frame 12 and the adapter frame 14 are coupled via their axis of rotation 16 and the rocker mechanisms, which of which has a rocker 18, a tension spring 22, and a draw bar 20, such that, when the machine frame 12 swings downwards about the axis of rotation 16, in particular when the pick-up attachment 10 travels into a depression, the tension spring 22 extends and the spring force thereof is correspondingly increased, as shown in FIG. 7, and vice versa, such that, when the machine frame 12 swings upwards about the axis of rotation 16, in particular when the pick-up attachment 10 travels up a summit, the tension spring 22 contracts and the spring force thereof is correspondingly decreased, as shown in FIG. 5.

According to the invention, a defined distance or leverage forms between the effective direction 38 of the tension spring 22, i.e., in the direction in which the spring force acts, and the axis of rotation 16, or the pivot point, which, in an operative connection with the spring force of the tension spring 22, partially guides the weight of the machine frame 12 into the adapter frame 16 such that the ground pressure, or the supporting force of the guide elements 30 on the ground 28, changes.

The tension spring 22 is preloaded in a predefined or predefinable manner, wherein the preload of the tension spring 22 is adjustable or changeable by means of an adjusting screw 42.

The axis of rotation 16 is arranged at the level of the intake auger base 34.

The machine frame 12, which is hingedly attached to the adapter frame 14, swings about the axis of rotation 16 or the pivot point such that no or only slight changes in the transfer geometry between pick-up attachment 10 and pre-compression housing of the harvesting machine arise during the up-and-down-swinging motion.

The two guide elements 30, which are designed as roller feelers 30a, 30b, are arranged on the left and the right as seen in the direction of travel FR, laterally next to the pick-up rotor 24 and approximately at the level of the pick-up rotor 24 as seen in the direction of travel FR.

The contact point of the two roller feelers 30a, 30b with the ground 28 is arranged, as seen in the direction of travel FR, approximately next to the contact point of the pick-up tools 26, in particular, pick-up tines, or rake tines, of the pick-up rotor 24 with the ground, the so-called rake point.

The distance of the pick-up tools 26, in particular of the pick-up tines, or rake tines, of the pick-up rotor 24 to the ground 28, or the rake height, is adjustable using the guide elements 30, or roller feelers 30a, 30b, arranged laterally next to the pick-up rotor 24.

The pick-up attachment 10 can, as shown in FIG. 8, have an actuator 46, preferably a hydraulic actuator, by means of the actuation of which the swing angle, or the swinging motion 48, of the rocker 18 is overridable, wherein the machine frame 12 is movable either into an upper end position or into a lower end position, wherein the actuation is preferably implementable from the driver's cab of the harvesting machine.

The adapter frame 14 can, as shown in FIG. 8, be additionally provided with a lateral tilt frame 50, which permits the pick-up attachment 10 to swing back and forth transversely to the direction of travel FR.

For the electronic height guidance, an angle sensor 52 can be provided, as shown in FIG. 9, which detects the relative motion between machine frame 12 of the pick-up attachment 10 and adapter frame 14 of the pick-up attachment 10 and converts the relative movement into an electrical signal, wherein the signal is then usable to detect the position of the pick-up rotor 24, or of the machine frame 12 of the pick-up attachment 10, relative to the adapter frame 14 of the pick-up attachment 10, or to the pre-compression housing of the harvesting machine, which is usable to control a pre-compression housing arranged on the pick-up attachment 10, which is tracked such that the swinging machine frame 10 returns to a starting position in which the machine frame 10 is in a central position.

### LIST OF REFERENCE NUMERALS

10 pick-up attachment
12 machine frame
14 adapter frame
16 axis of rotation
18 rocker
18a rocker arm
18b rocker arm
20 draw bar
22 tension spring
24 pick-up rotor
26 pick-up tool
28 ground
30 guide element
32 hold-down device
34 intake auger base
36 intake auger
38 effective direction or longitudinal axis of the tension spring
40 straight line
42 adjusting screw
44 axis of rotation of the rocker
46 actuator
48 swinging motion
50 lateral tilt frame
52 angle sensor
FR direction of travel

1. A pick-up attachment (10) for a harvesting machine having, in particular, a pre-compression housing, preferably for a forage harvester having, in particular, a pre-compression housing, particularly preferably for a self-propelled forage harvester having, in particular, a pre-compression housing, wherein the pick-up attachment (10) has a machine frame (12), wherein the pick-up attachment (10) has an adapter frame (14), to the forward-facing side of which, as seen in the direction of travel (FR), the machine frame (12) is hingedly attached and to the rearward-facing side of which the pre-compression housing of the harvesting machine, or the harvesting machine, is coupleable so as to be fixed in place, wherein the machine frame is swingable or tiltable downwards and upwards relative to the adapter frame (14) about an axis of rotation (16) arranged transversely to the direction of travel (FR), arranged in the lower region of the machine frame (12) and of the adapter frame, or about at least one correspondingly arranged pivot point, wherein at least one rocker mechanism is provided, comprising a rotatably mounted rocker (18), which is arranged on the adapter frame (14) in the upper region of the adapter frame (14) and has two rocker arms (18a, 18b), wherein the one rocker arm (18a) is attached to the machine frame (12) in the upper region of the machine frame (12) directly or indirectly, preferably via a draw bar (20), wherein the other rocker arm (18b) is attached to the machine frame (12) in the lower region of the machine frame (12) or to the adapter frame (14) in the lower region of the adapter frame (14) via a tension spring (22) or the like.

2. The pick-up attachment (10) of claim 1, wherein the rocker (18) is tiltable about an axis of rotation (44) arranged transversely to the direction of travel (FR), or about at least one correspondingly arranged pivot point, wherein the axis of rotation (44) of the rocker (18), or at least one correspondingly arranged pivot point, is arranged at a predefined distance above the axis of rotation (16) formed between the adapter frame (14) and machine frame (12).

3. The pick-up attachment (10) of claim 1, wherein the pick-up attachment (10) has two rocker mechanisms, wherein the one rocker (18) is arranged on the left outer side of the adapter frame (14) as seen in the direction of travel (FR) and the other rocker (18) is arranged on the right outer side of the adapter frame (14) as seen in the direction of travel (FR).

4. The pick-up attachment (10) of claim 1, wherein the pick-up attachment (10) comprises a pick-up rotor (24) with pick-up tools (26) for picking up crop from the ground (28), at least one guide element (30) lying on the ground (28), which takes on the guidance of the pick-up rotor (24) and guides this towards the ground (28), a hold-down device (32), an intake auger base (34), and an intake auger (36) for uniformly handing off the picked-up crop to the harvesting machine.

5. The pick-up attachment (10) of claim 1, wherein the machine frame (12) and the adapter frame (14) are coupled via their axis of rotation (16) and the at least one rocker mechanism, which has a rocker (18), a tension spring (22), and, optionally, a draw bar (20), such that, when the machine frame (12) swings downwards about the axis of rotation (16), in particular when the pick-up attachment (10) travels into a depression, the tension spring (22) extends and its spring force is correspondingly increased, and vice versa, such that, when the machine frame (12) swings upwards about the axis of rotation (16), in particular when the pick-up attachment (10) travels onto a summit, the tension spring (22) contracts and its spring force is correspondingly decreased.

6. The pick-up attachment (10) of claim 1, wherein a defined distance or leverage is formed between the effective direction (38) of the tension spring (22) and the axis of rotation (16), or the pivot point, which, in an operative connection with the spring force of the tension spring (22), partially guides the weight of the machine frame (12) into the adapter frame (16) such that the ground pressure, or the supporting force of the guide elements (30) on the ground (28), changes.

7. The pick-up attachment (10) of claim 1, wherein the tension spring (22) is preloaded.

8. The pick-up attachment (10) of claim 1, wherein the preload of the tension spring (22) is adjustable or changeable, preferably by means of an adjusting element, in particular an adjusting screw (42), which has the tension spring (22).

9. The pick-up attachment (10) of claim 1, wherein the axis of rotation (16) is arranged at the level of the intake auger base (34).

10. The pick-up attachment (10) of claim 1, wherein attached to the machine frame (12) are the pick-up rotor (24), the hold-down device (32), the intake auger base (34), and the intake auger (36) and these, together with the machine frame (12), form a machine frame unit, wherein this machine frame unit is suspended swinging up and down relative to the pre-compression housing of the harvesting machine, in particular of the forage harvester.

11. The pick-up attachment (10) of claim 1, wherein the machine frame (12), which is hingedly attached to the adapter frame (14), swings about the axis of rotation (16) or the pivot point such that no or only slight changes in the transfer geometry between the pick-up attachment (10) and the pre-compression housing of the harvesting machine arise during the up-and-down-swinging motion.

12. The pick-up attachment (10) of claim 1, wherein two guide elements (30), which are preferably designed as roller feelers (30a, 30b), are arranged on the left and the right as seen in the direction of travel (FR), laterally next to the pick-up rotor (24), preferably approximately at the level of the pick-up rotor (24) as seen in the direction of travel (FR).

13. The pick-up attachment (10) of claim 9, wherein the contact point of the two guide elements (30), preferably of the roller feelers (30a, 30b), with the ground (28) is arranged, as seen in the direction of travel, approximately next to the contact point of the pick-up tools (26), in particular pick-up tines, or rake tines, of the pick-up rotor (24) with the ground, the so-called rake point.

14. The pick-up attachment (10) of claim 1, wherein the distance of the pick-up tools (26), in particular of the pick-up tines, or rake tines, of the pick-up rotor (24), to the ground (28), or the rake height, is adjustable via the guide elements, preferably roller feelers (30a, 30b) arranged laterally next to the pick-up rotor (24).

15. The pick-up attachment (10) of claim 1, wherein the guide elements, preferably roller feelers (30a, 30b), are mechanically, hydraulically, and/or electrically movable with respect to their height to adjust the distance of the pick-up tools (26), in particular of the pick-up tines, or rake tines, of the pick-up rotor (24), to the ground (28).

16. The pick-up attachment (10) of claim 1, wherein the adjustment of the distance of the pick-up tools (26), in particular of the pick-up tines, or rake tines, of the pick-up rotor (24) to the ground (28) is implementable decentrally at the particular guide element, preferably roller feeler (30a, 30b), or centrally from the driver's cab of the harvesting machine and preferably simultaneously for all guide elements.

17. The pick-up attachment (10) of claim 1, wherein an actuator (46), preferably a hydraulic actuator, is provided, by means of the actuation of which the swing angle, or the swinging motion (48), of the rocker (18) is overridable, wherein the machine frame (12) is movable either into an upper end position or into a lower end position, wherein the actuation is preferably implementable from the driver's cab of the harvesting machine.

18. The pick-up attachment (10) of claim 1, wherein the adapter frame (14) is additionally provided with a lateral tilt frame (50), which permits the pick-up attachment (10) to swing back and forth transversely to the direction of travel (FR).

19. The pick-up attachment (10) of claim 1, wherein one or more than one sensor, preferably angle sensor (52), is provided for electronic height guidance, which detects the relative movement between machine frame (12) of the pick-up attachment (10) and adapter frame (14) of the pick-up attachment (10) and converts the relative movement into an electrical signal, wherein the signal is then usable to detect the position of the pick-up rotor (24), or of the machine frame (12) of the pick-up attachment (10), relative to the adapter frame (14) of the pick-up attachment (10), or to the pre-compression housing of the harvesting machine, which is usable to control a pre-compression housing arranged on the pick-up attachment (10), which is tracked such that the swinging machine frame (12) returns to a starting position in which the machine frame (10) is in a central position.

20. The pick-up attachment of claim 1, wherein the pick-up attachment (10) connected to the harvesting machine is manually adjustable at the harvesting machine to a constant predefined height above the ground, preferably such that the machine frame is spring-deflected by 50% relative to the adapter frame (14).
